(19) United States
(12) Patent Application Publication
(10) Pub. No.: US 2024/0102698 A1
(43) Pub. Date: Mar. 28, 2024

(54) SOLAR ENERGY COLLECTION SYSTEM AND RELATED METHODS

(71) Applicant: Mun Chew Kong, Singapore (SG)

(72) Inventor: Stephen D. Newman, Singapore (SG)

(21) Appl. No.: 18/474,022

(22) Filed: Sep. 25, 2023

Related U.S. Application Data
(60) Provisional application No. 63/377,039, filed on Sep. 25, 2022.

(51) Int. Cl. F24S 23/30; F24S 10/00; F24S 30/42; G02B 19/00

(52) U.S. Cl. CPC F24S 23/30; F24S 10/00; F24S 30/42; G02B 19/0009; G02B 19/0042

(57) ABSTRACT

An energy collection system including a collection apparatus having a light concentrating lens is disclosed. The light concentrating lens can include a light receiving surface and a light exiting surface opposite the light receiving surface. The light exiting surface includes a curved shape configured to direct light passing through the lens to a focal point. The energy collection system further includes a concentrator apparatus having a conduit and an energy absorbing medium within the conduit to convert the solar energy to thermal energy.

### RELATED APPLICATION

The present application claims priority from previously filed U.S. Provisional Patent Application No. 63/377,039 filed 25 Sep. 2022, titled “Solar Energy Collection System and Related Methods,” which application is incorporated herein by reference in its entirety.

### FIELD

The described embodiments relate generally to systems and methods for collecting solar energy, and more particularly, to radiation concentration and thermal collection systems.

### BACKGROUND

Solar thermal systems can collect solar radiation in order to store energy in a transfer medium. Conventional solar thermal systems can be bulky and rely heavily on mirrors, which can lose reflective and refractive efficiency due to degradation and contaminant build-up on the mirrors. Conventional systems can be unsuited to capture solar radiation as the sun moves through a day arc without otherwise using power-intensive tracking devices. Further, the bulkiness and weight of such systems can limit the installation and adaptability of the system.

### SUMMARY

Embodiments disclosed herein relate to solar energy collection, and more particularly to a light concentrating lens and energy collection system and methods to supply energy to an energy absorbing medium. In some embodiments, a light concentrating lens can include a light receiving surface and a light exiting surface opposite the light receiving surface. In some embodiments, the light exiting surface can include a curved shape configured to direct light passing through the lens to a focal point. In some examples, the light receiving surface can include a planar surface. In other examples, the light receiving surface can include a convex surface. The light exiting surface can include a convex surface. In some embodiments, the light exiting surface can include a curvature greater than the curvature of the light receiving surface.

In some embodiments, the lens can be configured to generate a back focal length of about 15 mm. In some embodiments, the lens can be configured to generate a focus length NA value between about 0.3 and about 0.5. The lens can include a cylindrical focusing lens. In some embodiments, the lens can include a central thickness between about 5 mm to about 40 mm.

In some embodiments, an energy collection system can include a collection apparatus having a light concentrating lens and a light receiver. The energy collection system can also include a concentrator apparatus having a conduit and an energy absorbing medium within the conduit. In some embodiments, the collection apparatus can further include a single axis solar tracking device. In some embodiments, the collection apparatus can further include a seasonal tilt device.

In some embodiments, the light receiver can include a concave surface relative to the lens. In some embodiments, the conduit can include a transparent material. The energy absorbing medium can include at least one of a perovskite material, water, glycol, oil, refrigerant, molten salt, and zeolite-based fluid.

In some embodiments, a method for transferring energy to a fluid can include conducting a fluid through a conduit. The conduit can be disposed within a light receiver. The method can further include concentrating light through a lens to a focal point on the light receiver. In some embodiments, the lens comprises a first surface configured to receive the light and a second surface configured to direct the light passing through the lens to the focal point. The fluid can include at least one of water, glycol, oil, refrigerant, molten salt, and zeolite-based fluid. In some embodiments, the light receiver can include a concave surface relative to the lens. In some embodiments, the lens can include a cylindrical rod lens and concentrating light can include installing the cylindrical rod lens with an optical axis oriented in a North-South direction. In some embodiments, concentrating light can include tracking the solar angle with a single axis tracking function.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 illustrates a schematic cross-sectional view of a light concentrating lens, according to an embodiment.

FIG. 2 illustrates a cross-sectional view of an energy collection system, according to an embodiment.

FIG. 3A illustrates an isometric view of a model showing light passing through a collection apparatus of an energy collection system in several angles, according to an embodiment.

FIG. 3B illustrates a spot diagram for different field angles of light passing through a collection apparatus of an energy collection system in several angles, according to an embodiment.

FIG. 4A illustrates a sequential model showing light passing through a cross section of a light concentrating lens onto a flat concentrator apparatus, according to an embodiment.

FIG. 4B illustrates a graphical representation of the Root mean square radius value that indicates performance of the light concentrating lens and light receiver, according to an embodiment.

FIG. 5A illustrates a sequential model showing light passing through a cross section of a light concentrating lens onto a concave concentrator apparatus, according to an embodiment.

FIG. 5B illustrates a graphical representation of the Root mean square radius value that indicates performance of the light concentrating lens and light receiver, according to an embodiment.

FIG. 6A illustrates a sequential model showing light passing through a cross section of a light concentrating lens onto a concave concentrator apparatus, according to an embodiment.

FIG. 6B illustrates a graphical representation of the Root mean square radius value that indicates performance of the light concentrating lens and light receiver, according to an embodiment.

FIG. 7A illustrates graphical representations of a maximum radiance at different incidence angles for three different designs of concentrator apparatus, according to an embodiment.

FIG. 7B illustrates a graphical representation comparing configurations of components of an energy collection system.

FIG. 8 illustrates an isometric view of an energy collection system, according to an embodiment.

FIG. 9A illustrates a schematic view of a portion of an energy collection system, according to an embodiment.

FIG. 9B illustrates a schematic view of a portion of an energy collection system including a single axis solar tracking device, according to an embodiment.

FIG. 9C illustrates a schematic view of a portion of an energy collection system including a single axis tracking device with a seasonal tilt device, according to an embodiment.

FIG. 10 illustrates a method for transferring energy to a fluid, according to an embodiment.

### DETAILED DESCRIPTION

The present disclosure relates to systems and methods to facilitate the collection and concentration of solar radiation into a heat transfer medium. An energy collection system including a collection apparatus and a concentrator apparatus can be provided to collect solar radiation and transfer thermal energy to a heat transfer medium. The collection apparatus can include a light concentrating lens or, in some embodiments, a plurality of light concentrating lenses that are arranged about the heat transfer medium. The concentrating lenses can be adapted to collect the solar radiation and direct and focus the radiation toward the heat transfer medium. The heat transfer medium receives the focused radiation and stores the radiation as heat energy.

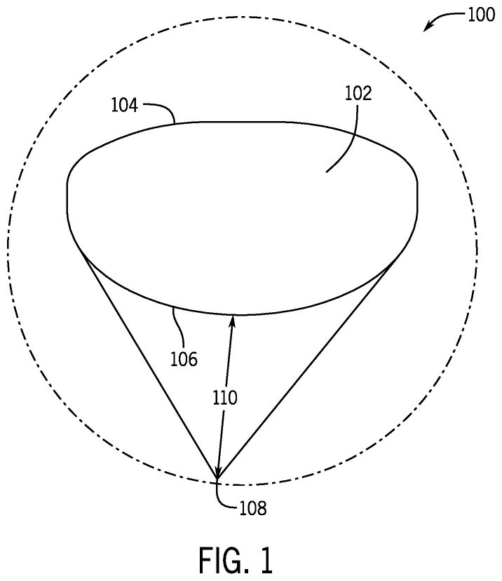

FIG. 1 illustrates a schematic cross-sectional view of a light concentrating lens 100, according to an embodiment. The light concentrating lens 100 includes a lens body 102. In some examples, the lens body 102 can include a cylindrical rod lens. However, other lens designs are also included, including micro-pyramid lenses and Fresnel type lenses. The lens 100 can include a light receiving surface 104 and a light exiting surface 106 generally opposite the light receiving surface 104. In some examples, the light exiting surface 106 can include a curved shape configured to direct light passing through the lens to a focal point.

In some embodiments, the lens 100 as a rod lens can include a front surface curvature of about 60 mm. For example, the front surface curvature of the lens body 102 can be about 30 mm or greater, about 45 mm or greater, about 60 mm or greater, or in ranges of about 30 mm to about 50 mm, about 50 mm to about 65 mm, or about 65 mm to about 80 mm. The rod lens can include a back surface curvature of about 7.5 mm. For example, the back surface curvature of the lens body 102 can be about 2 mm or greater, about 5 mm or greater, about 7 mm or greater, or in ranges of about 2 mm to about 5 mm, about 5 mm to about 7 mm, or about 7 mm to about 10 mm.

In some embodiments, the rod lens can include a tube radius of about 30 mm. For example, the tube radius of the lens body 102 can be about 10 mm or greater, about 20 mm or greater, about 30 mm or greater, about 40 mm or greater, or in ranges of about 10 mm to about 20 mm, about 20 mm to about 30 mm, about 30 mm to about 40 mm, or about 40 mm to about 50 mm.

In some embodiments, the light receiving surface 104 and the light exiting surface 106 can be optimized for solar radiation concentration. In some embodiments, the light receiving surface 104 can include a generally planar surface. In other embodiments, the light receiving surface 104 can include a non-planar surface. The light exiting surface 106 can include a semicircle shape. In some embodiments, the light exiting surface 106 includes a curvature greater than the curvature of the light receiving surface 104. Additionally or alternately, one or both of the surfaces can include a plurality of refractive surfaces. The lens 100 can be disposed in an energy collection system

The lens body 102 can be configured to direct light to a single focal point 108. The lens can include a cylindrical focusing lens. In some embodiments, the lens body 102 includes a back focal length 110 of about 15 mm. In some embodiments, the lens body 102 can include a back focal length 110 of less than 15 mm. The back focal length 110 of the lens body 102 can include a length 110 of between about 5 mm and about 20 mm. For example, the back focal length of the lens body 102 can be about 5 mm or greater, about 10 mm or greater, about 15 mm or greater, or in ranges of about 5 mm to about 10 mm, about 10 mm to about 15 mm, or about 15 mm to about 20 mm. In some embodiments, the lens body 102 can include a focus length numerical aperture (NA) value between about 0.3 and about 0.5. In some embodiments, the lens body can include N-BK7 glass or other suitable material.

The light concentrating lens 100 can be formed of a material that is at least partially transparent. In some embodiments, the material can include In some examples, the material of the light concentrating lens 100 can have the characteristic of having at least 20 percent total transmittance, at least 30 percent total transmittance, at least 40 percent total transmittance, at least 50 percent total transmittance, at least 60 percent total transmittance, at least 70 percent total transmittance, at least 80 percent total transmittance, at least 85 percent total transmittance, at least 90 percent total transmittance, at least 95 percent total transmittance, another appropriate total transmittance, or combinations thereof. In some examples, the light concentrating material can be a glass, a plastic or polymer, a resin, diamond, sapphire, ceramics, another type of material, or combinations thereof.

As the light enters the receiving surface 104, the light can be refracted when the entering or received light is not perpendicular to the light receiving surface 104. In this case, the substantially parallel light rays that are generally traveling towards, but not focused on the focal point, can be refracted due to the relative angle between the incoming light and the light receiving surface 104. This refraction that occurs at the light receiving surface 104 can be a refractive angle of a light ray that bends a natural light ray into a partially refracted light ray. The light concentrating lens 100 can cause the partially refracted light ray to bend into a focused light ray on the focal point. Thus, the light can be refracted at multiple points while still traveling in the general direction towards the focal point.

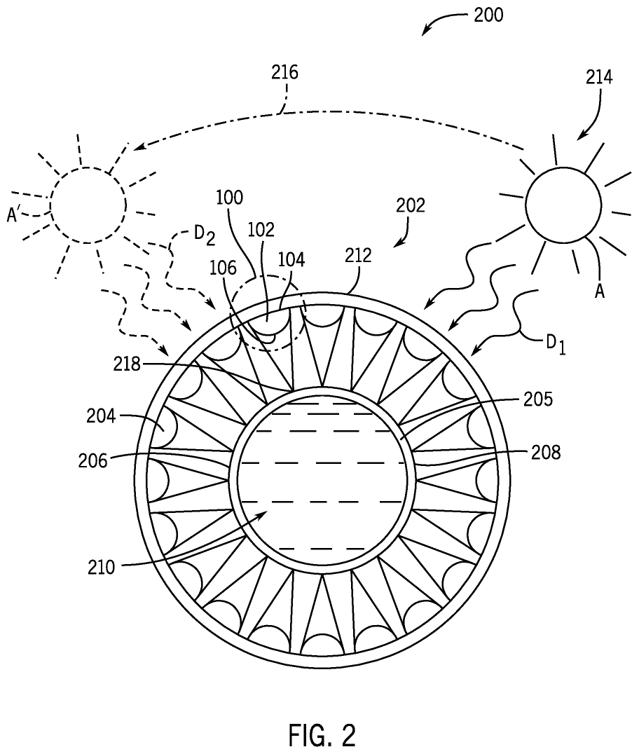

FIG. 2 illustrates a cross-sectional view of an energy collection system 200, according to an embodiment. The energy collection system 200 can include a collection apparatus 202 including a light concentrating lens 204 (e.g. light concentrating lens 100 including light receiving surface 104 and light exiting surface 106) and a light receiver 205. In some embodiments, the energy collection system 200 can further include a concentrator apparatus 206. The concentrator apparatus 206 can include a conduit 208 and an energy absorbing medium 210 disposed within the conduit 208. In other embodiments, the energy absorbing medium 210 can include photovoltaic cells. In some embodiments, the light receiver 205 can include the conduit 208 and/or an outer surface of the conduit 208. In some examples, the conduit 208 can include a transparent material. The conduit 208 can include a glass or polymer. In some embodiments, as the sun emits solar radiation in the direction of the collection system 200, the energy collection system 200 can include a series of light concentrating lenses 204 comprising a light receiver 212 of the collection apparatus 202. The sun 214 can emit solar radiation along a direction D1 when the sun 214 is in the first position A. The sun 214 can emit solar radiation along a direction D2 when the sun 214 is in the second position A′. The energy collection system 200 can receive solar radiation from the sun 214 from the first direction D1 and the second direction D2 and direct and concentrate the solar radiation to the concentrator apparatus 206. In some embodiments, the solar radiation can be received without moving or manipulating the collection apparatus 202.

The arrangement of light concentrating lens 204 within the collection apparatus 202 can include any appropriate number of concentrating lenses in order to facilitate the omnidirectional concentration of light from the light receiver 212. For example, the concentrating lenses 204 can be positioned about the concentrator apparatus 206, such as about circumference of the conduit 208. In some examples, the concentrating lenses 204 can be substantially evenly circumferentially spaced about the collection apparatus 202. This arrangement can allow a subset of the concentrating lenses 204 to receive solar radiation from the sun 214 as the sun travels through a day arc 216, as at least one or more of the concentrating lenses 204 substantially directly faces the sun 214 for a given position of the sun 214 along the day arc 216. In this regard, it will be appreciated that any appropriate number of concentrating lenses 204 can be integrated with the energy collection system 200 in order to capture solar radiation from a variety of different azimuths and altitudes of the sun 214. In the illustrated example, 20 concentrating lenses 204 are provided. However, in other cases, more or fewer lenses can be provided, such as providing at least 30 lenses, at least 50 lenses, at least 70 lenses, at least 100 lenses, or more about and/or around the concentrator apparatus 206.

In some embodiments, the concentrating lenses 204 may be arranged in a pattern and/or configured such that the rod lenses are not parallel to the conduit 208. In an embodiment, the concentrating lenses 204 may be arranged in a herringbone pattern along the length of the collection apparatus 202. In some embodiments, the concentrating lenses 204 may be arranged horizontal and/or perpendicular to the conduit 208. In some embodiments, the concentrating lenses 204 may be arranged in a spiral and/or star pattern around the conduit 208. The arrangement of concentrating lenses 204 may be configured to improve the efficiency of energy collection, increase optimal solar angles, reduce manufacturing costs, make the collection apparatus 202 easier to clean or maintain clear, and/or improve durability. The concentrating lenses 204 may be arranged in any suitable pattern. In some embodiments, an alternate pattern (e.g. herringbone) may alter the peak hours of solar efficiency during a predetermined time period (e.g. a day).

Each lens of the arrangement of concentrating lenses can be adapted to concentrate light toward a focal point 218 on or adjacent the concentrator apparatus 206. Each concentrating lens of the arrangement can have a respective focal point 218. For purposes of illustration, each concentrating lens 204 is shown having a light receiving surface and a light exiting surface. Each concentrating lens 204 can be adapted to collect and direct light toward a unique focal point 218. Each focal point 218 can be different points from the light receiver 212 onto the concentrator apparatus 206. In some embodiments, one or more of the concentrating lens 204 can be arranged such that one or more or all of the focal points overlap.

In some embodiments, as described above, the concentrator apparatus 206 can include conduit 208 and an energy absorbing medium 210 within the conduit 208. The energy absorbing medium 210 can be any appropriate medium that is configured to receive thermal energy through the concentrator apparatus 206. For example, the energy absorbing medium 210 can have an initially cooler temperature upon entering the concentrator apparatus 206. The energy absorbing medium 210 can include a fluid that can receive thermal energy from the sun 214 via the collection apparatus 202. The energy absorbing medium 210 can receive thermal energy notwithstanding the position of the sun 214 along the day arc 216. The energy absorbing medium 210 can include photovoltaic materials that can be configured to convert solar energy to electricity directly.

For example, when the sun 214 is in the first position A, the arrangement of concentrating lenses 204 can cooperate to receive and concentrate energy toward the conduit 208 and the energy absorbing medium 210 held therein. Further, when the sun 214 is in the second position A′, the arrangement concentrating lenses 204 or the light receiver 205 cooperate to receive and concentrate energy toward the medium 210. In turn, the energy absorbing medium 210 can exit the concentrator apparatus 206 at an elevated temperature from a temperature of the fluid 210 upon entry into the concentrator apparatus 206. The energy absorbing medium 210 can be subsequently routed to other components of a thermal system to extract the energy from the medium 210. For example, the energy collection system 200 can further include a heat exchanger coupled to the concentrator apparatus 206. In some embodiments, the energy absorbing medium 210 can include at least one of a perovskite material, water, glycol, oil, refrigerant, molten salt, an a zeolite-based fluid.

A perovskite material includes the same crystal structure as calcium titanium oxide. In some embodiments, perovskite may be a semiconductor installed in the energy collection system 200 and configured to turn the light energy into electricity. Light from the sun excites electrons in the semiconductor perovskite material, which flow into conducting electrodes and produce electric current. Due to the tenability of perovskite material, the material may include properties similar to the abundantly used but expensive to manufacture silicon crystals. The large silicon crystals used in conventional solar panels require an expensive, multi-step manufacturing process that utilizes a lot of energy. Perovskite solar cells can be manufactured using simple, additive deposition techniques, like printing, for a fraction of the cost and energy. Because of the compositional flexibility of perovskites, they can also be tuned to ideally match the sun's spectrum. In other embodiments, the perovskite material may be combined with a silicon to produce silicon solar cells with a perovskite coating, which may collect high-energy photons.

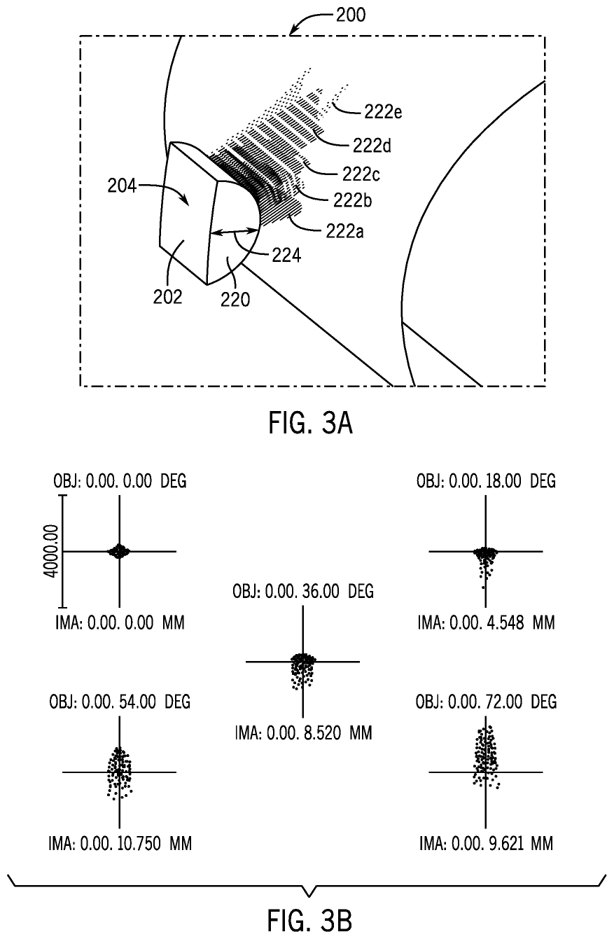

FIG. 3A illustrates an isometric view of light passing through a collection apparatus 202 of an energy collection system 200 in several angles, according to an embodiment. As described above, the collection apparatus 202 can include a light concentrating lens 204. In some embodiments, the light concentrating lens 204 can include a rod lens 220. FIG. 3A shows a portion of the rod lens 220. The rod lens 220 can include a cylindrical focusing lens. The rod lens 220 can include a light receiving surface and a light exiting surface opposite the light receiving surface as described with reference to FIG. 1.

In some embodiments, the rod lens 220 can be optimized for seasonal changes of sun path. The rod lens 220 can include a lenslet. In some embodiments, the rod lens 220 can be divided into lenslets to compensate for solar angle changes with season by introducing a small change in curvature by including a lenslet. In some embodiments, optical principles can be optimized with unique designs to capture more sunlight and focused energy. The optics create a highly focused and planar cylinder including a short focal length in a linear array that mitigates the need to track the sun. In other words, oblique adjacent rays will still provide energy to the concentrator apparatus 206 and heat the energy absorbing medium 210. In some embodiments, half Maddox optics can be focused as a bi-aspheric convex or planar cylinder to create an extended depth of field (EDOF) effect in the energy absorbing medium 210.

The light receiving surface and the light exiting surface can be optimized for solar radiation concentration by modeling the rod lens as biconic or a similar type surface. Compared to a rotationally symmetric conic surface, the biconic surface has two more degrees of freedom with different curvature and conic parameters in the x and y direction. The surfaces can thus be tuned such that the rod lens 220 can be configured to capture solar radiation in the most efficient manner. A biconic lens adds refractive power to the east-west axis of the rod lens 220, which may help to spread focusing due to seasonal change of sun path. By dividing the rod lens into biconic lenslets, a relatively small change in curvature can induce refractive power to compensate for the skew angle along the north-south direction. In some embodiments, multiple foci generated by the bionic lenslets will distribute along the original receiver surface. A significant advantage of bionic lenslets include an improvement in geometric concentration such as higher energy density. The overall area of the array of a point-like foci is much smaller than the continuous line focus of the rod lens 220 having the same width, and the biconic lenslets can produce a higher maximum concentration ratio for the same solar collection area.

In some embodiments, the focus length can include an NA value of between about 0.3 and about 0.5 to maintain a high eating effect at focus. In optics, the numerical aperture (NA) of an optical system is a dimensionless number that characterizes the range of angles over which the system can accept or emit light. By incorporating index of refraction in its definition, NA includes the property that it is constant for a beam as it goes from one material to another, provided there is no refractive power at the interface. The design of the rod lens 220 can include a focusing efficiency for a wide range of incident ray angles. In some examples the range of incident ray angles include any suitable angle and may not be limited to the following examples. FIG. 3A illustrates 5 exemplary angles. The first angle 222a has the cylindrical focusing lens arranged at 0° relative to the Y axis. The second angle 222b has the cylindrical focusing lens arranged at 18° relative to the Y axis. The third angle 222c has the cylindrical focusing lens arranged at 36° relative to the Y axis. The fourth angle 222d has the cylindrical focusing lens arranged at 54° relative to the Y axis. The fifth angle 222e has the cylindrical focusing lens arranged at 72° relative to the Y axis. In some examples, as the angle increases the root mean square (RMS) radius increases. In other words, as the incident angle increases, there is a larger spread of light rays at the concentrator apparatus 206 (e.g. the conduit 208).

FIG. 3B illustrates a spot diagram for different field angles of light passing through a collection apparatus of an energy collection system in several angles, according to an embodiment. In some embodiments, the central thickness 224 of the lens can affect the propagation of the rays. For a central thickness of 15 mm, the RMS radius in an example spot diagram increases significantly as the incident angle increases. Table 1 indicates example values of RMS radius at the defined angles. Table 2 indicates example values of RMS radius at the defined angles for a central thickness 224 of 7.5 mm. The focusing property of the lens indicates an improvement through all example angles.

TABLE 1

| | | | | | |
|---|---|---|---|---|---|
| Angle (degrees) | 0 | 18 | 36 | 54 | 72 |
| RMS Radius | 2206 | 2688 | 3211 | 4188 | 8188 |

TABLE 2

| | | | | | |
|---|---|---|---|---|---|
| Angle (degrees) | 0 | 18 | 36 | 54 | 72 |
| RMS Radius | 2132 | 2114 | 2077 | 2212 | 2848 |

The solar energy has been concentrated to a small area in all four field angles as included in a sequential mode, and show similar RMS radius value. However, when the energy density/radiance is included in non-sequential mode, the energy density at a surface of the concentrator apparatus can vary significantly. A threshold level at 80% of the maximum Radiance can show the energy concentration ratio for four incident angles are 8.6 (0 degree), 8.7 (18 degree), 7.8 (36 degree) and 6.1 (54 degree). The solar efficiency, calculated by percentage of total number of traced light beams hitting the image plane, is 69.64%, 74.87%, 78.32% and 79.95% for 0, 18, 36 and 54 degree incident angles, respectively. Thus, the solar concentration ratio remains stable across angles up to 36 degrees. An obvious drop at 54 degree is found, which is due to the lower optimization weighting assigned to the angle.

When multiple wavelengths are included in the non-sequential mode, a maximum radiance at the surface of the concentrator apparatus can indicate the performance of the lens. The results are shown below in Table 3.

TABLE 3

| Incident angle | | | | |
|---|---|---|---|---|
| (degrees) | 0 | 18 | 36 | 54 |
| 486 nm | 0.94 | 0.93 | 0.86 | 0.68 |
| 587 nm | 0.95 | 0.95 | 0.85 | 0.66 |
| 656 nm | 0.95 | 0.95 | 0.85 | 0.65 |
| 800 nm | 0.94 | 0.93 | 0.82 | 0.63 |
| 1000 nm | 0.94 | 0.93 | 0.82 | 0.63 |
| 1200 nm | 0.94 | 0.93 | 0.81 | 0.61 |

### Maximum Radiance (w/cm2) at Image Plane for Different Wavelength and Incident Angles

As shown, with different wavelengths there was almost no change in maximum radiance for smaller incident angles of <18°. A 5% (dropped 0.05 w/cm2 from 0.86 w/cm2) and 10% (dropped 0.07 w/cm2 from 0.68 w/cm2) loss were observed for incident angles of 36 degree and 54 degree, when the input wavelength changed from 486 nm to 1200 nm.

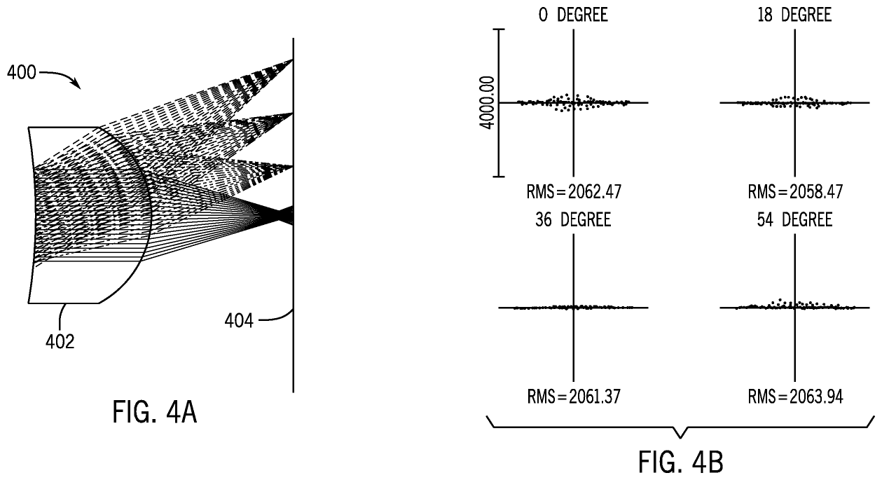

FIG. 4A illustrates a sequential model 400 showing light passing through a cross section of a light concentrating lens 402 onto a flat concentrator apparatus 404, according to an embodiment. In some embodiments, the shape of the concentrator apparatus 404 can be optimized to improve efficiency of the energy collection system. FIG. 4A indicates a baseline design for the components of an energy collection system. FIG. 4B illustrates a graphical representation of the Root mean square (RMS) radius value that indicates performance of an example light concentrating lens and light receiver, according to an embodiment. The values of FIG. 4B represent the efficiency of the shapes of the concentrator apparatus at provided angles of light. FIG. 4B illustrates the RMS values at 0°, 18°, 36°, and 54°, respectively.

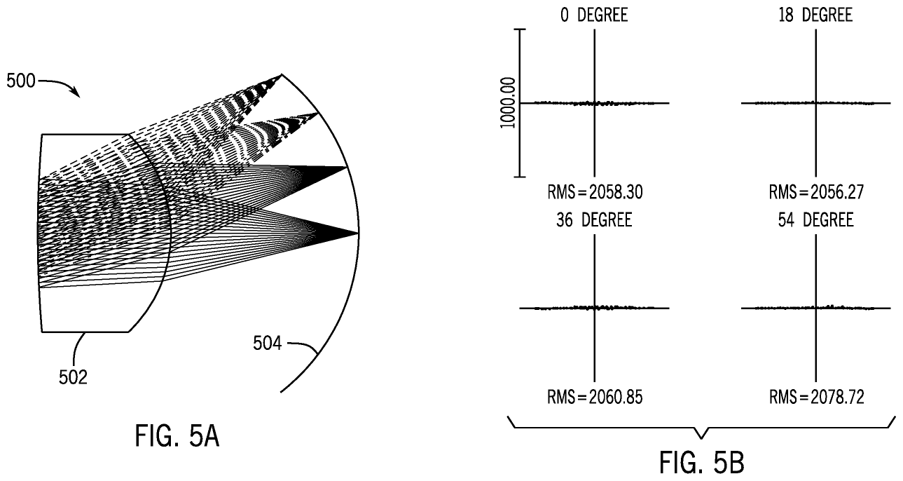

FIG. 5A illustrates a sequential model 500 showing light passing through a cross section of a light concentrating lens 502 onto a concave concentrator apparatus 504, according to an embodiment. In some embodiments, the concentrator apparatus 504 can include about the same curvature as the light exiting surface of the light concentrating lens 502. FIG. 5B illustrates a graphical representation of the Root mean square radius value that indicates performance of the light concentrating lens and light receiver, according to an embodiment. Slight improvements can be shown with respect to the data shown in FIG. 4B.

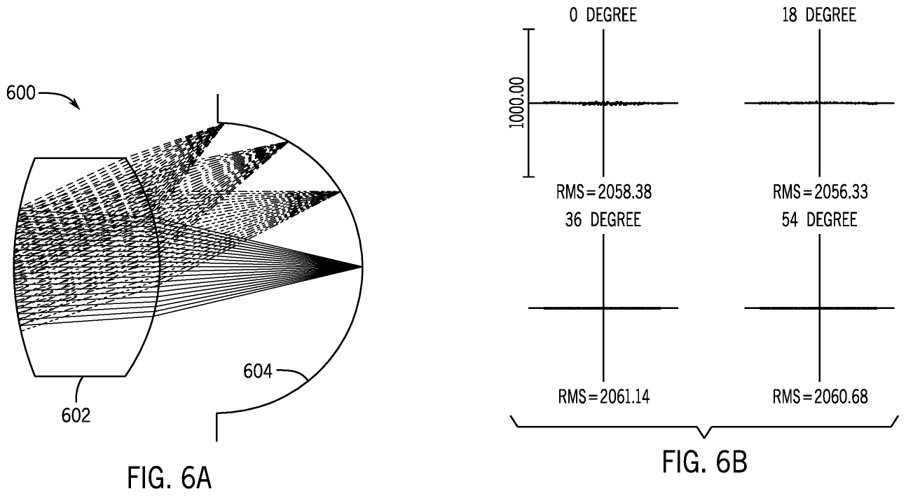

FIG. 6A illustrates a sequential model 600 showing light passing through a cross section of a light concentrating lens 602 onto a concave concentrator apparatus 604, according to an embodiment. In some embodiments, the concentrator apparatus 604 can include a greater curvature than the light exiting surface of the light concentrating lens 602. FIG. 6B illustrates a graphical representation of the Root mean square radius value that indicates performance of the light concentrating lens and light receiver, according to an embodiment. Slight improvements can be shown with respect to the data shown in FIG. 4B and at greater light angles than the data shown in FIG. 5B.

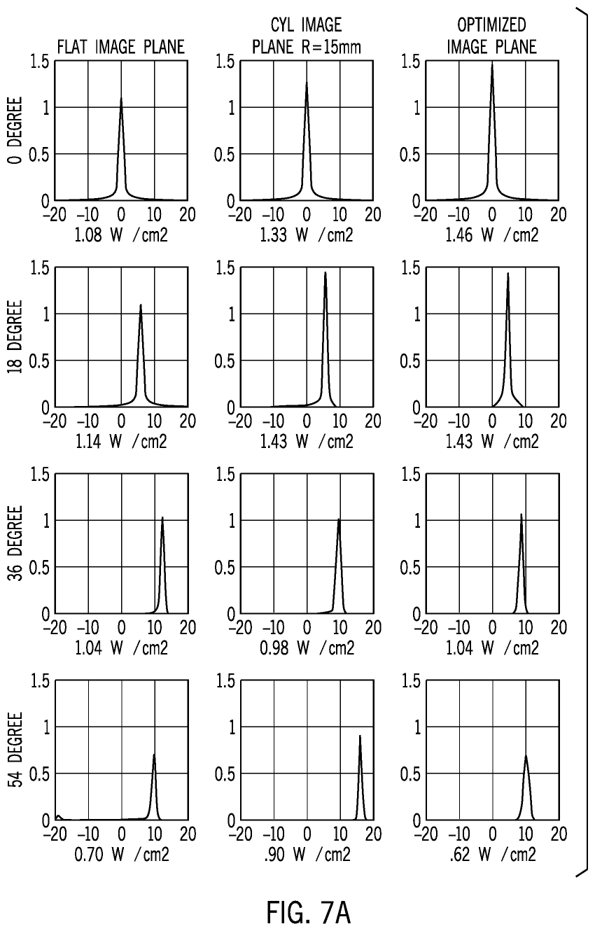

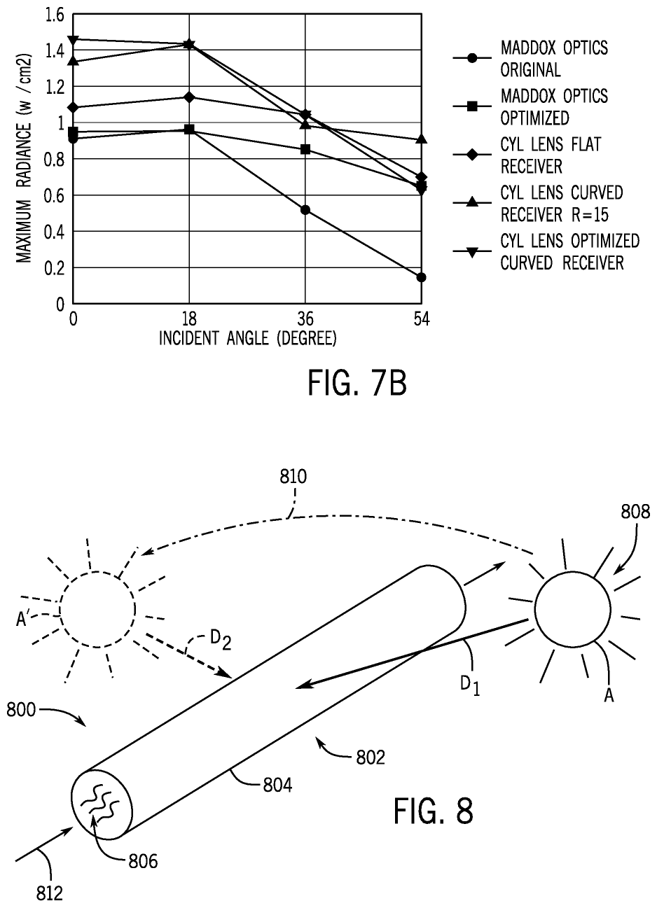

In sequential models, the RMS radius value from these three designs as shown in FIGS. 4A-6A of the concentrator apparatus may only show small differences. However, when the three shapes are compared in a non-sequential mode for radiance analysis with an input radiance level of 0.1 mw/cm2, the concentrator apparatus having a concave surface shows a greater radiance. FIG. 7A illustrates graphical representations of a maximum radiance at different incidence angles for three different designs of concentrator apparatus, according to an embodiment. The first column is in reference to the flat concentrator apparatus surface as shown in FIG. 4A. The second column is in reference to the concentrator apparatus that includes about the same curvature as the light exiting surface of the light concentrating lens and the third column of FIG. 7A is in reference to the concentrator apparatus that includes a concavity surface greater than the light exiting surface of the light concentrating lens. All three designs show great focusing improvement throughout the range of solar incidence angles, compared to the original Maddox (cylindrical design) as shown in FIGS. 3A-3B.

FIG. 7B illustrates a graphical representation comparing configurations of components of an energy collection system. The graph indicates the radiance delivered through various angles. In some embodiments, an energy collection system can be improved by including a light concentrating lens having a curved surface and a concentrator apparatus including a concave surface. However, the curved surface of the concentrating lens and concentrator apparatus is not required. Generally, the incident angle is the highest indicator of radiance. A curved receiver also has a high correlation with radiance effectiveness and/or efficiency.

FIG. 8 illustrates an isometric view of an energy collection system 800, according to an embodiment. The light concentrating lenses and collection systems described above can be implemented into an energy collection system 800 that is adapted to concentrate solar radiation that is received from a plurality of different angles. The energy collection system 800 can include a concentrator apparatus 802 comprising a conduit 804 and an energy absorbing fluid 806 within the conduit 804. In some embodiments, the conduit 804 can include a transparent material, including the transparent materials provided above with respect to FIG. 1. In some embodiments, a plurality of the light concentrating lenses can be arranged around the conduit 804 such that at least a subset of the lenses receive solar radiation at a low incident angle at a given point in the day. This can allow the concentrator apparatus 802 to receive solar energy as the sun moves along a day arc.

By way of schematic illustration, FIG. 8 shows sun 808 relative to the concentrator apparatus 802. The sun 808 can generally move along day arc 810 between a first position A and a second position A′. The sun 808 can emit solar radiation along a direction D1 when the sun 808 is in the first position A. The sun 808 can emit solar radiation along a direction D2 when the sun 808 is in the second position A′. The concentrator apparatus 802 can be adapted to receive solar radiation from the sun 808 from the first direction D1 and the second direction D2 and direct and concentrate the solar radiation to an energy absorbing fluid within the conduit 804. In some embodiments, the solar radiation can be received without moving or manipulating the lens and other optical components of the concentrator apparatus 802. In some examples, the concentrator apparatus 802 can be perpendicular to the sun arc 810. In other examples, the concentrator apparatus 802 can include an angle incident to the sun arc 810, which depending on the elevation and latitude of the concentrator apparatus, can optimize the solar radiation from the sun 808.

In some embodiments, the energy absorbing fluid 806 can be introduced to the concentrator apparatus 802 at an inlet 812 of the concentrator apparatus 802. The energy absorbing fluid 806 can receive thermal energy from the sun 808 via the concentrator apparatus 802. The energy absorbing fluid 806 can receive thermal energy in concentrated form from the sun 808 notwithstanding a position of the sun 808 along the day arc 810. In some embodiments, the energy absorbing fluid 806 can include at least one of water, glycol, oil, refrigerant, molten salt, and zeolite-based fluid.

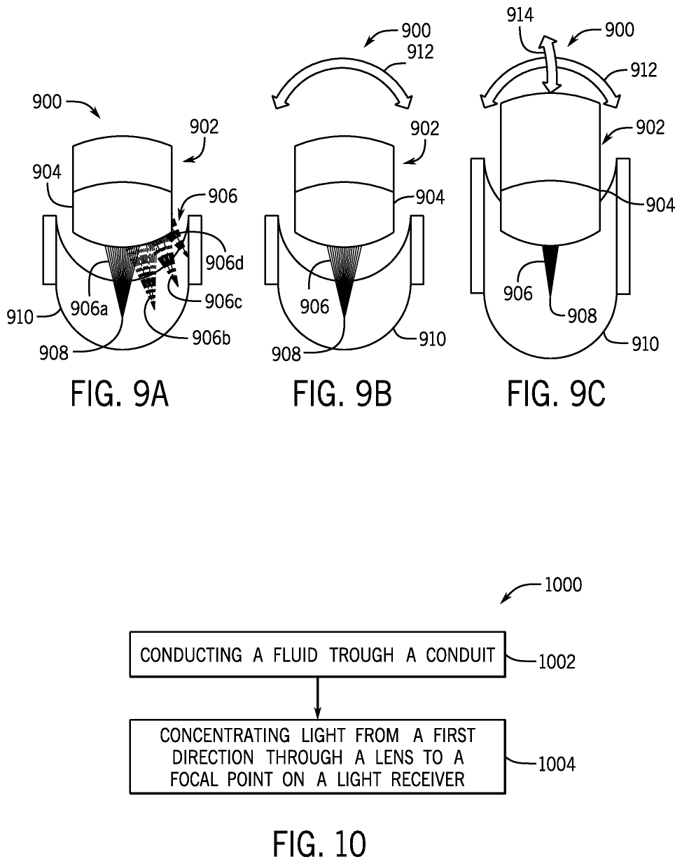

FIG. 9A illustrates a schematic view of a portion of an energy collection system 900, according to an embodiment. In some embodiments, the energy collection system 900 can include a collection apparatus 902 including a light concentrating lens 904. The light concentrating lens 904 can be optically shaped for energy collection along a solar arc as described in other embodiments above. FIG. 9A includes various streams of light 906. For example, a stream of light passing through the light concentrating lens at 0°, 18°, 36°, and 54° as indicated by stream of light 906a, 906b, 906c, and 906d, respectively. The streams of light 906 can be configured to direct the light passing through the lens 904 to a focal point 908.

The energy collection system 900 can further include a light receiving surface 910. In some embodiments, the light receiving surface 910 can include a concave surface relative to the light concentrating lens 904. In some embodiments, the curvature and/or concavity of the light receiving surface 910 can be greater than the curvature of the convex surface of the light concentrating lens. When the focusing rod lens is installed with the optical axis orienting to the North-South direction without a tracking function, the focusing lens is designed to collect solar energy within a range of −54 to +54 degrees East-West. In some embodiments, the light concentrating lens 904 can include a cylindrical rod lens and be configured to concentrate light from a first direction by installing the cylindrical rod lens with an optical axis oriented in a North-South direction

FIG. 9B illustrates a schematic view of a portion of the energy collection system 900. In some embodiments, the energy collection system 900 can include a single axis solar tracking device 912, according to an embodiment. In some embodiments, the single axis solar tracking device 912 can be configured to shift the angle of the light concentrating lens 904 to track along a solar arc. By tracking the solar arc with the lens, the energy collection system 900 can receive sunlight at angles shown to increase energy efficiency for a longer portion of the day. The single axis solar tracking device 912 can be configured to track the solar arc from the morning to afternoon. Equipped with 1 axis tracking function to follow the hourly changes of solar angle, the focusing lens has 4 more hours of available solar time and shows higher focusing efficiency in the early morning and late afternoon hours, compared to the fixed installation condition without tracking. However, in an embodiment that includes a single axis solar tracking device 912, when the solar angle decreases on the North-South direction with seasonal changes, the focusing efficiency of the energy collection system 900 can be reduced up to about 50% at an offset angle of 26 degrees and further decreased as the offset angle increases.

FIG. 9C illustrates a schematic view of a portion of the energy collection system 900 including a single axis tracking device 912 and further including a seasonal tilt device 914, according to an embodiment. In some embodiments, the collection apparatus further includes seasonal tilt device 914 to compensate for the changes of declination angle of the sun relative to the light concentrating lens 904. Due to a tilted rotation axis of 23.45 degree, as the earth rotates around the sun through the course of a year, the declination angle changes within a range of ˜+/−23.45 degrees. With the geography coordinates (latitude, longitude) of a solar site of interest, one can obtain the sun position at different times during the year. In some embodiments, the seasonal tilt may include compensation for latitude placement of the energy collection system 900. In some embodiments, the energy collection system 900 can compensation for the variation in sun paths for a collection system placed at a first latitude (e.g. the equator) and a collection system placed at a second latitude (e.g. 40.1421 N).

FIG. 10 illustrates a method 1000 for transferring energy to a fluid, according to an embodiment. As shown in block 1002, in some embodiments, the method 1000 can include conducting a fluid through a conduit. The conduit can be disposed within a light receiver. The method 1000 can further include concentrating light through a lens to a focal point on the light receiver, as shown in block 1004. The lens can include a first surface configured to receive the light and a second surface configured to direct the light passing through the lens to the focal point.

In some embodiments, the fluid comprises at least one of water, glycol, oil, refrigerant, molten salt, and zeolite-based fluid. The fluid can be any suitable fluid that acts as a heat transfer medium. In some embodiments, the light receiver comprises a concave surface relative to the lens. The lens can include a cylindrical rod lens and concentrating light from a first direction can include the act of installing the cylindrical rod lens with an optical axis oriented in a North-South direction. In some embodiments, concentrating light from a first direction can include tracking the solar angle with a single axis tracking function.

Various disclosures have been described herein with reference to certain specific embodiments and examples. However, those skilled in the art recognize that many variations are possible without departing from the scope and spirit of the disclosures discussed herein, in that those disclosures set forth in the claims below are intended to cover all variations and modifications of the disclosures discussed without departing from the spirit of the disclosure. The terms “including:” and “having” come as used in the specification and claims shall have the same meaning as the term “comprising.”

The foregoing description, for purposes of explanation, used specific nomenclature to provide a thorough understanding of the described embodiments. However, it can be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It can be apparent to one of ordinary skill in the art that many modifications and variations are possible in view of the above teachings.

What is claimed is:

1. A light concentrating lens, comprising:
a light receiving surface;
a light exiting surface opposite the light receiving surface, wherein the light exiting surface comprises a curved shape configured to direct light passing through the lens to a focal point.

2. The light concentrating lens of claim 1, wherein the light receiving surface comprises a planar surface.

3. The light concentrating lens of claim 1, wherein the light receiving surface comprises a convex surface.

4. The light concentrating lens of claim 1, wherein the light exiting surface comprises a convex surface.

5. The light concentrating lens of claim 1, wherein the light exiting surface comprises a curvature greater than the curvature of the light receiving surface.

6. The light concentrating lens of claim 1, wherein the lens is configured to generate a back focal length of about 15 mm.

7. The light concentrating lens of claim 1, wherein the lens is configured to generate a focus length NA value between about 0.3 and about 0.5.

8. The light concentrating lens of claim 1, wherein the lens comprises a cylindrical focusing lens.

9. The light concentrating lens of claim 1, wherein the lens comprises a central thickness between about 5 mm to about 40 mm.

10. An energy collection system, comprising:
a collection apparatus comprising a light concentrating lens and a light receiver; and
a concentrator apparatus comprising a conduit and an energy absorbing medium within the conduit.

11. The energy collection system of claim 10, wherein the collection apparatus further comprises a single axis solar tracking device.

12. The energy collection system of claim 10, wherein the collection apparatus further comprises a seasonal tilt device.

13. The energy collection system of claim 10, wherein the light receiver comprises a concave surface relative to the lens.

14. The energy collection system of claim 10, wherein the conduit comprises a transparent material.

15. The energy collection system of claim 10, wherein the energy absorbing medium comprises at least one of a perovskite material, water, glycol, oil, refrigerant, molten salt, and zeolite-based fluid.

16. A method for transferring energy to a fluid, the method comprising:
conducting a fluid through a conduit, wherein the conduit is disposed within a light receiver; and
concentrating light through a lens to a focal point on the light receiver, wherein the lens comprises a first surface configured to receive the light and a second surface configured to direct the light passing through the lens to the focal point.

17. The method of claim 16, wherein the fluid comprises at least one of water, glycol, oil, refrigerant, molten salt, and zeolite-based fluid.

18. The method of claim 16, wherein the light receiver comprises a concave surface relative to the lens.

19. The method of claim 16, wherein the lens comprises a cylindrical rod lens and concentrating light comprises installing the cylindrical rod lens with an optical axis oriented in a North-South direction.

20. The method of claim 19, wherein concentrating light comprises tracking the solar angle with a single axis tracking function.
